(19) United States
(12) Patent Application Publication
(10) Pub. No.: US 2013/0034047 A1
(43) Pub. Date: Feb. 7, 2013

(54) METHOD AND SYSTEM FOR COMMUNICATING WITH WEB SERVICES USING PEER-TO-PEER TECHNOLOGY

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA)

(73) Assignee: XTREME LABS INC., Toronto (CA)

(21) Appl. No.: 13/566,407

(22) Filed: Aug. 3, 2012

Related U.S. Application Data
(60) Provisional application No. 61/515,414, filed on Aug. 5, 2011.

(51) Int. Cl. H04W 40/02

(52) U.S. Cl. 370/315

(57) ABSTRACT

A method is provided for pushing a data packet containing a message from a server to a mobile device not in direct communication with the server. A data packet is formulated for transmission, which comprises a message and a header (including a target identifier of a device intended to receive the message). The data packet is then transmitted to at least one peer push backbone device in direct communication with the server. The peer push backbone device then subsequently relays the data packet to other devices within range of the peer push backbone device, and instructs said other devices to further relay the data packet to other devices within range of each of those said devices until a device is reached that has the target identifier. An automatic indication is received from the peer push backbone device once the packet has reached the device having the target identifier.

### CROSS REFERENCE TO RELATED APPLICATION

This application claims priority from U.S. Provisional Application No. 61/515,414 filed on Aug. 5, 2011, which is incorporated by reference in its entirety herein.

### TECHNICAL FIELD

The invention relates to methods and systems for using peer-to-peer technology to distribute messages, and more particularly relates to such methods and systems using peer-to-peer as a push technology.

### BACKGROUND

As the number of Internet-connected devices continues to rise, so too does the demand for Internet-based data. These demands are increasingly provided through web services, and consist of bursts of automated data, which can be provided to a particular device's application for specific processing. For example, a mobile device's communications client may receive electronic mail or messages. Weather warnings, breaking world news and stock market alerts may be used by other applications resident on a local mobile device.

Rather than delivering these groups of data at timed intervals, transmission is often provided by Push Technology, which describes a synchronous communication system in which the request for a given transaction is initiated by a publisher or by a centralized server. By synchronous it is meant that one central server or device is trying to push a notification to many recipients all at the same time, with no priority between the intended recipients. This well-established process is often based on a subscription model, and is synonymous with push notifications, an alerting system used by cellular providers in mobile devices on their network. This is in direct opposition to traditional Pull Technology, which is initiated by the receiver or client, and, for example, describes the process used by web browsers.

By design, Push Technology requires a direct and robust connection to the centralized server or other device providing the data. In real-life applications, however, this procedure can be complicated by a number of mitigating factors, including but not limited to, radio reception levels, radio interference, current tower load and available bandwidth. Practically, this limits the effectiveness and overall reliability of the push communications scheme, hindering the use of such push methods for delivering critical and time-sensitive data.

Peer-to-peer computing or networking, on the other hand, is a maturing asynchronous process, in which networks of peers, or nodes, are equally privileged participants, sharing a portion of their resources in order to distribute a task or workload among peers. For example, there is no priority between them as to when they are intended to receive data. In a centralized peer-to-peer system, data originates from a centralized server, which acts as a coordinator, providing indexing functions. These indexing functions permit the centralized server to keep track of who has been sent content and who has not been sent content. In a decentralized peer-to-peer system, distributed data stores are maintained and shared within a structured system, providing the required connection and distribution information among peers. Peer-to-peer technology is used extensively in file sharing and Internet-based telephony.

It would be desirable if mobile devices themselves could be used as push servers to facilitate transmission of messages using a hybrid peer-to-peer model.

### SUMMARY

According to a first aspect of the invention, a method is provided for pushing a data packet containing a message from a server to a mobile device not in direct communication with the server. A data packet is formulated for transmission. The data packet comprises a message and a header. The header comprises a target identifier of a device intended to receive the message. The data packet is then transmitted to at least one peer push backbone device in direct communication with the server. The peer push backbone device then subsequently relays the data packet to other devices within range of the peer push backbone device, and instructs said other devices to further relay the data packet to other devices within range of each of those said devices until a device is reached that has the target identifier. An automatic indication is received from the peer push backbone device once the packet has reached the device having the target identifier.

In one embodiment, the message is an encrypted message. The method may also include receiving from the peer push backbone device an automatic indication that the encrypted message has been deciphered by the device having the target identifier.

Preferably, the target identifier comprises an identifier unique to the span of the peer-to-peer network (eg. Mobile Device IMEI).

Preferably, the peer push backbone device forms a structured subsystem with the other devices within its range. For example, the structured subsystem may comprise devices sharing the same cell tower or IP block as the peer push backbone device.

Preferably, the message comprises a message readable on the device. Alternatively, the message may comprise a pointer to a message readable on the device.

Preferably, the header further comprises at least one gateway, which identifies at least one device intermediate to the device having the target identifier.

Preferably, each relay includes an exchange of addresses of the devices, which are sent back to the central server. Preferably, each address comprises an identifier unique to the span of the peer-to-peer network (eg. Mobile Device IMEI).

According to a second aspect of the invention, a programmed mobile device is provided for transmitting messages within a peer-to-peer network. The mobile device includes server software that (1) listens for a request to transmit a data packet (the packet includes a message and a header, and the header includes a target identifier of a device intended to receive the message); (2) checks a routing table for routing instructions; (3) sends the data packet to at least one peer device within range, in accordance with the routing instructions; and (4) receives an indication that the packet was received by the intended recipient device, and returns that indication to the device that sent the request.

### BRIEF DESCRIPTION OF THE FIGURES

FIG. 1 is a structural overview of peer-to-peer push technology.

FIG. 2 is a functional overview contrasting conventional push technology with the peer-to-peer push technology of the present invention.

### DETAILED DESCRIPTION

Systems and methods disclosed herein provide a distributed environment to mitigate at least some of the aforementioned disadvantages of traditional Push technology.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device (preferably, a mobile device) that enables a user to engage with an application is provided as a component of the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the Internet. The storage media can be inserted to the console where it is read. The console can then read program instructions stored on the storage media and present a user interface to the user.

In some embodiments, the device has a graphical user interface (GUI) that the user interacts with in one or several known ways (e.g. touch screen, keypad, voice activation, keyboard, etc.). The device also has one or more processors, memory and one or more modules, programs or sets of instructions stored in the memory for performing multiple functions. As is well-known, the device may include other functions such as providing maps and directions, telephoning, video conferencing, e-mailing, instant messaging, blogging, digital photography, digital videoing, web browsing, digital music playing, and/or digital video playing. Instructions for performing these functions may be included in a computer readable storage medium or other computer program product configured for execution by one or more processors.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to persons skilled in the art.

The computer program comprises: a computer usable medium having computer usable program code, the computer usable program code comprises: computer usable program code for presenting graphically to the users options for scrolling via the touch-screen interface.

The invention relates to various devices, including without limitation, a personal computer (PC), which may include but not limited to a home PC, corporate PC, a Server, a laptop, a Netbook, a Mac, as well as, various types of mobile and other electronic devices, including a cellular phone, a Smartphone, a PDA, an iPhone, an iPad, an iPod, a PVR, a settop box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Source Device where content is located or generated and Recipient Device where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or ones that will become available as a result of the advancements made in such industries.

This system defines a hybrid peer-to-peer configuration, in which centralized servers act as infrastructure nodes, distributing arbitrary push data blocks to connected mobile devices acting as nodes within the main network. These nodes then redistribute the data to additional devices within their range using structured subsystems, maintained through distributed data stores and messages to and from peers indicating what messages have been sent or received. This allows push data to reach devices which would otherwise be unable to maintain a synchronous connection to the central server. Structured subsystems can span several radio bands and protocols, ensuring maximum reach.

A structured subsystem in the node is the container that holds the routing information, the mechanism that controls the routing and the input/output link to the other nodes. This is formed through connecting to a peer network.

Data blocks will preferably be encrypted using specific target identification variables, such as IMEI, in order to ensure secure transmission from source to destination. Upon successful deciphering by a target device, confirmation flags will be set, which will propagate through the network, to be detected by distributed data stores occurring at nodes with the network. Upon detection, additional flags will be set, purging the particular data block from the networks.

Although seamless to the end-user, this asynchronous approach using peer-to-peer networking ensures a more robust and error-resistant means of implementing push technology. The loss of any given centralized server has a negligible impact on the overall quality of service offered to connected mobile devices, and data can be received where previously such transmission was difficult.

Available protocols (TCP/IP, Bluetooth, etc.) can be used to provide a P2P architecture to deliver data that is seeded by those with access (i.e. carriers) and use specifications of the device (i.e. locality, carrier, IMEI, etc.) to limit the spread. Immediate peers in the network could be devices on the same cell tower, same IP block, etc. The principle requirement is that devices are capable of responding to this network.

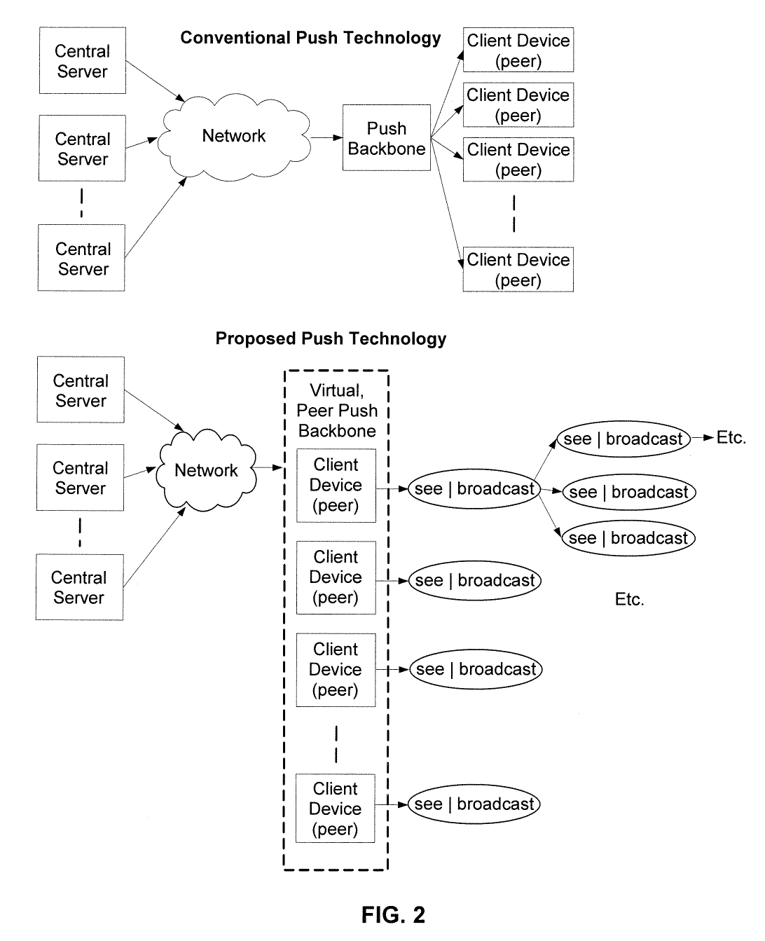

For clarification, in FIG. 2, a comparison is made between conventional push methods and the peer push method employed by the present invention. Note the replacement of the Push Backbone with a Virtual Peer Push Backbone. Functionally, peers see and broadcast data packet such that they propagate in their network whether or not directly connected to central servers.

Preferably physical/network proximity of a device to the message creator may be the main factor in determining which devices are to be included in the virtual push backbone device (e.g. devices connected to the same cell tower). These devices can be identified as nodes (example: all connected devices in communication with the same cell tower) provided they have not received data in the mesh network.

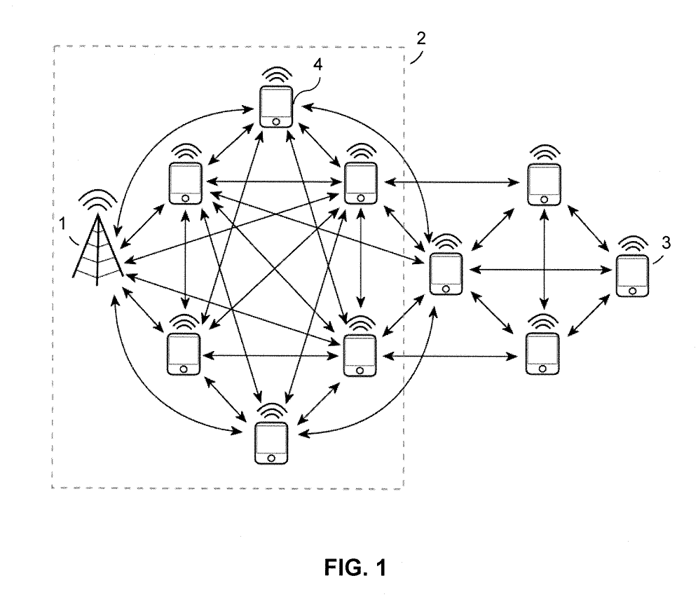

Referring to FIG. 1, a centralized server 1 acts as a supernode, in a centralized peer-to-peer system acting as a main network, connected to all devices 4 within range, represented by the dotted area 2. Devices 3 which are outside the direct transmit range of the centralized server 1 and which would normally be unable to communicate, can now form structured subsystems with other devices within their range, who may in turn be communicating with the centralized server. Push notifications distributed by the centralized server 1 will propagate through the main network 2 and all subnetworks until the intended recipient is found. A mobile device 3 which would otherwise be unable to receive notifications directly from the centralized server 1 may now receive said notifications, aided by the relaying of data by other devices within the networks.

The following provides details how structured subsystems within and outside the range of a centralized server are created. Overall, each mobile device acts as a router and as a push server.

Each mobile device 3, 4 consists of a transceiver, data server and a routing table. The routing table may preferably be a list of device identifiers e.g. a list of IMEIs. Each device receiving data sends an acknowledgment back to the device that sent the data. If no acknowledgment is received from a certain device within a given window of time, its IMEI is deleted from the routing table. Thus the routing table is dynamically kept up to date. The centralized server 1 can access the device's 4 digital transceiver. This permits the server to constantly listen for and broadcast to peer devices on chosen supported radio frequencies in the physical realm. The routing table is maintained to keep track of peer devices' unique identifier and data which is intended to be sent to each such peer (or a pointer to that data) and, optionally, confirmation that data was sent to the peer and received by the peer. In an embodiment, the unique identifier is the device's address assigned to it by the central server. The unique identifier of the device (the destination) is contained in the header of data packets. It may also contain intermediary waypoints called gateways, themselves addresses of peer devices. The nature of the unique address depends on the protocol utilized, such as but not limited to TCP/IP and Bluetooth.

TCP/IP is an example packet protocol. Using TCP/IP, a simple table would be stored in each node (structured subsystem) that maps which peers the node should send a message to. It also handles updating the send-to-node-list. TCP/IP is an example implementation.

Devices within radio transceiver range exchange their addresses. When a device is activated, it broadcasts its device-specific identifier such as IMEI. If the central server is within range, the device receives a unique address directly. If not, neighboring peers repeatedly forward the device-specific identifier such as IMEI until it reaches the central server. The centralized server receives the request to join the network and assigns a unique address. The unique address is then broadcast to peers in range, that in turn forward the assigned address to the requesting device. In this way, all devices are assigned a unique address necessary to their roles as routers and gateways, regardless of their respective ranges to the central server. Additionally, the system can be adapted to make use of existing protocols and transfer systems, as necessary or required.

Structured subsystems outside the range of a central server area are created by a collection of peer devices interconnected directly with each other and with devices within range of a central server. Data is propagated as data packets hop from one device to another via their internal servers on each mobile device that act as routers or gateways until the destination in the peer to peer network is reached. Since each router or gateway is actively transmitting packets, they are in effect “pushing” data to peers.

Data from the Internet as data packets enters the peer to peer network from the central server. Data is transmitted to and from the Internet by the central server. Thus the present invention requires that at least one peer in the network is connected to the central server for minimal functionality.

The server software located in the peer devices 3, 4 listen for requests from not only the central server but from peers as well. Receiving peers are maintained in the routing table. Whether a server on a peer device accepts and processes incoming data packets depends on the routing table. Transmission of outgoing data packets is indiscriminate, in other words is sent to all receiving peers.

In one embodiment of the invention it may advantageously be deployed by carriers. In such an embodiment preferably filtering by IMEI can be a way to choose receiving peers. Peers themselves maintain a virtual push server backbone. FIG. 2 demonstrates the difference between prior art and the present invention. In prior art, a push backbone is present. A primary component of this backbone is a push server. In the present invention, a portion of the push server is virtual and distributed among peers. In this model, peers that are part of the virtual push backbone see and re-broadcast data packets to peers not part of the backbone directly in communication with the central server.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to persons skilled in the art.

What is claimed is:

1. A method of pushing a data packet containing a message from a server to a mobile device not in direct communication with the server, comprising:
formulating a data packet for transmission, comprising a message and a header, the header comprising a target identifier of a device intended to receive the message;
transmitting the data packet to at least one peer push backbone device in direct communication with the server, the peer push backbone device subsequently relaying the data packet to other devices within range of the peer push backbone device, and instructing said other devices to further relay the data packet to other devices within range of each of those said devices until a device is reached that has the target identifier; and
receiving from the peer push backbone device an automatic indication that the packet has reached the device having the target identifier.

2. The method of claim 1, wherein the message is encrypted.

3. The method of claim 2, further comprising receiving from the peer push backbone device an automatic indication that the encrypted message has been deciphered by the device having the target identifier.

4. The method of claim 1, wherein the target identifier comprises an IMEI of the device.

5. The method of claim 1, wherein the peer push backbone device forms a structured subsystem with the other devices within its range.

6. The method of claim 1, wherein the structured subsystem comprises devices sharing the same cell tower or IP block as the peer push backbone device.

7. The method of claim 1, wherein the message comprises a message readable on the device.

8. The method of claim 1, wherein the message comprises a pointer to a message readable on the device.

9. The method of claim 1, wherein the header further comprises at least one gateway, the gateway identifying at least one device intermediate to the device having the target identifier.

10. The method of claim 1, wherein each relay includes an exchange of addresses of the devices, the addresses being sent back to the central server.

11. The method of claim 10, wherein each address comprises the IMEI of the device.

12. A programmed mobile device for transmitting messages within a peer-to-peer network, comprising server software for:
listening for a request to transmit a data packet, comprising a message and a header, the header comprising a target identifier of a device intended to receive the message;
checking a routing table for routing instructions;
in accordance with the routing instructions, sending the data packet to at least one peer device within range; and
receiving an indication that the packet was received by the intended recipient device, and returning that indication to the device that sent the request.
